(19) United States
(12) Patent Application Publication
(10) Pub. No.: US 2025/0309482 A1
(43) Pub. Date: Oct. 2, 2025

(54) BATTERY MODULE AND ENERGY STORAGE BATTERY PACK

(71) Applicant: Zhejiang Jinko Energy Storage Co., Ltd., Haining City (CN)

(72) Inventors: Yuanfu LV, Haining City (CN); Guochao CHEN, Haining City (CN); Yuanhang CHEN, Haining City (CN)

(21) Appl. No.: 18/931,069

(22) Filed: Oct. 30, 2024

(30) Foreign Application Priority Data
Mar. 27, 2024 (CN) 202410361545.9

(51) Int. Cl. H01M 50/503; H01M 50/522

(52) U.S. Cl. CPC H01M 50/503; H01M 50/522

(57) ABSTRACT

Provided are a battery module and an energy storage battery pack, relating to the field of energy storage. The battery module includes at least two battery cell groups, and at least one connecting member. Each respective battery cell group includes an output connector, and a plurality of battery cells arranged sequentially in a first direction, each battery cell has two electrodes, the plurality of battery cells includes an outermost battery cell having an electrode as an output electrode, the output connector includes a first electrical connection and a second electrical connection that are integrally formed, the first electrical connection is in electrical contact with the output electrode, and the first electrical connection has a material different from a material of the second electrical connection. Two ends of each respective connecting member are in electrical contact with second electrical connections of output connectors of respective two battery cell groups respectively.

### CROSS REFERENCE TO RELATED APPLICATIONS

The present disclosure claims the benefit of priority under the Paris Convention to Chinese Patent Application No. CN2024103615459, filed on Mar. 27, 2024, which is incorporated by reference herein in its entirety.

### TECHNICAL FIELD

Embodiments of the present disclosure relate to the field of energy storage, and in particular, to a battery module and an energy storage battery pack.

### BACKGROUND

In the related art, a plurality of battery cells are usually combined into a battery module first, a plurality of battery modules are mounted in series and parallel inside a battery pack, then electrical members and structural fixing members are installed, and finally the battery pack is mounted on a battery rack to form an entire battery cluster, thereby forming the whole energy storage system.

Battery modules are usually assembled in the battery pack, and the battery modules are electrically connected to each other through copper ribbons. A large number of wire harnesses exist in the battery pack, which usually pass through gaps between the battery modules. However, a current energy storage battery cabinet for accommodating the battery pack is compact in space, and in order to allow the battery cells to occupy a larger space so that the energy storage battery pack has a larger current-carrying capacity as well as a larger degree of integration, gaps between the battery modules may be relatively small, which in turn poses a greater challenge to aluminum bar as well as the contact performance of between the aluminum bar and the copper ribbon. As a result, the soldering performance between the aluminum bar and the copper ribbon is poorer, and the whole battery module has a larger loss and a poorer contact at the connection between the copper bar and the aluminum bar, which in turn affects the yield of the battery module.

### SUMMARY

Embodiments of the present disclosure provide a battery module and an energy storage battery pack, which at least facilitates improving the yield of the battery module.

According to some embodiments of the present disclosure, a battery module is provided in an aspect of embodiments of the present disclosure. The battery module includes at least two battery cell groups, and at least one connecting member. Each respective battery cell group of the at least two battery cell groups includes an output connector, and a plurality of battery cells arranged sequentially in a first direction. Each of the plurality of battery cells has two electrodes. The plurality of battery cells includes an outermost battery cell having an electrode as an output electrode. The output connector includes a first electrical connection and a second electrical connection that are integrally formed. The first electrical connection is in electrical contact with the output electrode, and the first electrical connection has a material different from a material of the second electrical connection. Two ends of each respective connecting member of the at least one connecting member are in electrical contact with second electrical connections of output connectors of respective two battery cell groups of the at least two battery cell groups, respectively.

In some embodiments, the material of the first electrical connection has a resistivity of 1.6×10⁻⁸ Ω·m to 5.0×10⁻⁷ Ω·m, and the material of the second electrical connection has a current-carrying capacity of 3 A/mm² to 10 A/mm².

In some embodiments, the material of the first electrical connection is a mono-metal or a metal alloy, the mono-metal being the same as a material of the output electrode, and the metal alloy including the same metal as the output electrode.

In some embodiments, the material of the first electrical connection includes aluminum.

In some embodiments, the second electrical connection includes a first sub-electrical connection and a second sub-electrical connection that are integrally formed, the first electrical connection wraps the first sub-electrical connection, the first sub-electrical connection is electrically connected to the output electrode, and the second sub-electrical connection is in electrical contact with the connecting member.

In some embodiments, the output connector further includes a third electrical connection disposed between the first electrical connection and the second electrical connection, a material of the third electrical connection including silver, gold, nickel or tin.

In some embodiments, the output connector further includes a fourth electrical connection surrounding at least a junction of the first electrical connection and the second electrical connection.

In some embodiments, the second electrical connections are integrally formed with the respective connecting member.

In some embodiments, materials of the second electrical connections are the same as a material of the respective connecting member.

In some embodiments, the material of the second electrical connection includes copper.

In some embodiments, the first electrical connection has a thickness less than or equal to a thickness of the second electrical connection.

In some embodiments, the first electrical connection is flush with the second electrical connection in a vertical direction.

In some embodiments, the respective connecting member includes: a body portion, a first bending portion, a second bending portion, a first connecting portion, and a second connecting portion. The body portion has a first side and a second side opposite to each other. The body portion extends from a second end of the body portion to a first end of the body portion in a second direction and from a first edge of the body portion to a second edge of the body portion in a third direction. The first bending portion and the second bending portion are respectively disposed at the first end and the second end of the body portion, the first bending portion is connected to the first end of the body portion and is bent from the first end of the body portion towards the third direction on the first side of the body portion, and the second bending portion is connected to the second end of the body portion and is bent from the second end of the body portion towards the third direction on the second side of the body portion. The first connecting portion is connected to an end of the first bending portion away from the body portion and is bent from the end of the first bending portion towards a fourth direction, and the fourth direction is a direction from the second side to the first side. The second connecting portion is connected to an end of the second bending portion away from the body portion and is bent from the end of the second bending portion towards the first direction, and the first direction is a direction from the first side to the second side.

In some embodiments, the first bending portion and the first side have a first distance in the first direction, the first bending portion and the second bending portion have a second distance in the first direction, and a ratio of the first distance to the second distance is in a range of 1% to 50%.

In some embodiments, the first distance ranges from 0 mm to 2.5 mm.

In some embodiments, the body portion has a buffer structure disposed between the first bending portion and the second bending portion.

According to some embodiments of the present disclosure, an energy storage battery pack is provided in another aspect of embodiments of the present disclosure. The energy storage battery pack includes several the battery modules in any of the preceding embodiments.

### BRIEF DESCRIPTION OF THE DRAWINGS

One or more embodiments are exemplarily described with reference to the corresponding figures in the accompanying drawings, and the descriptions are not to be construed as limiting the embodiments. Unless otherwise particularly stated, the figures in the accompanying drawings are not drawn to scale. To describe technical solutions of embodiments of the present disclosure or in the conventional technology more clearly, the following briefly introduces the accompanying drawings required for the embodiments. Apparently, the accompanying drawings in the following description show merely some embodiments of the present disclosure, and a person of ordinary skill in the art may still derive other drawings from these accompanying drawings without creative efforts.

FIG. 1 is a schematic view illustrating a structure of a battery cell group in a battery module according to an embodiment of the present disclosure.

FIG. 2 is a schematic view illustrating a partial structure of a battery module according to an embodiment of the present disclosure.

FIG. 3 is a schematic view illustrating a sectional structure of a first type of output connector in a battery module according to an embodiment of the present disclosure.

FIG. 4 is a schematic view illustrating a sectional structure of a second type of output connector in a battery module according to an embodiment of the present disclosure.

FIG. 5 is a schematic view illustrating a structure of a third type of output connector in a battery module according to an embodiment of the present disclosure.

FIG. 6 is a schematic view illustrating a structure of a fourth type of output connector in a battery module according to an embodiment of the present disclosure.

FIG. 7 is a schematic view illustrating a structure of a connecting member in a battery module according to an embodiment of the present disclosure.

FIG. 8 is a schematic diagram illustrating bending in FIG. 7.

FIG. 9 is a left view of FIG. 7.

FIG. 10 is a schematic view illustrating another structure of the connecting member in the battery module according to an embodiment of the present disclosure.

### DETAILED DESCRIPTION OF THE EMBODIMENTS

As can be seen from the Background that, current battery modules have poor yields.

Embodiments of the present disclosure provide a battery module and an energy storage battery pack, where the output connector includes a first electrical connection and a second electrical connection that are integrally formed, the first electrical connection is in electrical contact with the output electrode, and the first electrical connection has a different material from a material of the second electrical connection. For the first electrical connection electrically connected to the battery cell, the material of the first electrical connection may be suitably selected according to the consideration of a potential difference between the first electrical connection and the battery cell, which can avoid an undesirable problem caused by the redox reaction due to the potential difference between the first electrical connection and a positive pole or a negative pole in the battery cell. The first electrical connection may be also provided to include a material having better weldability with a material of the positive pole or the negative pole of the battery cell, so as to improve the contact performance between the first electrical connection and the positive pole or the negative pole of the battery cell. For the second electrical connection, more consideration is given to the overcurrent between the second electrical connection and the connecting member. The first electrical connection and the second electrical connection are designed to be integrally formed so that the welding difference between different materials can be avoided. In this way, there are better contact performance and less contact loss between the battery cell, output connector and connecting member, thus improving the yield of the battery module.

The following describes the embodiments of the present disclosure in detail with reference to the accompanying drawings. However, a person of ordinary skill in the art may understand that in the embodiments of the present disclosure, many technical details are provided to make readers better understand the embodiments of the present disclosure. However, even without these technical details and various changes and modifications based on the following embodiments, the technical solutions claimed in the embodiments of the present disclosure can be implemented.

In the description of the embodiments of the present disclosure, the technical terms “first” “second” and the like are only used to distinguish different objects and cannot be understood as indicating or implying relative importance or implicitly indicating the number, specific order, or primary and secondary relationship of the indicated technical features. In the description of the embodiments of the present disclosure, “a plurality of” means at least two, unless otherwise specified.

Reference herein to “embodiment” means that a particular feature, structure, or characteristic described in connection with the embodiment may be included in at least one embodiment of the present disclosure. The appearances of this phrase in various places in the specification are not necessarily all referring to the same embodiment, nor are separate or alternative embodiments that are mutually exclusive with other embodiments. It is explicitly and implicitly understood by those skilled in the art that the embodiments described herein may be combined with other embodiments.

In the description of the embodiments of the present disclosure, the term “a plurality of” means at least two, similarly, “a plurality of groups” means at least two groups, and “a plurality of pieces” means at least two pieces.

In the description of the embodiments of the present disclosure, orientation or positional relationship indicated by technical terms “length,” “width,” “thickness,” “up,” “down,” “front,” “rear,” “left,” “right,” “vertical,” “horizontal,” “top,” “bottom,” “inside,” “outside” and the like are orientations or positional relationships based on those shown in the accompanying drawings, which are intended only to facilitate the description of embodiments of the present disclosure and to simplify the description, and are not intended to indicate or imply that the device or element referred to must have a particular orientation, be constructed and operated with a particular orientation, and therefore are not to be construed as a limitation of the embodiments of the present disclosure.

In the description of the embodiments of the present disclosure, unless otherwise specified and limited, technical terms “mounted,” “connected,” “connecting,” “fixed,” etc. are to be understood in a broad sense. For example, it may be a fixed connection, a removable connection, or a one-piece connection, it may be a mechanical connection, or an electrical connection, it may be a direct connection, or an indirect connection through an intermediate medium, and it may be a connection between two elements or an interaction between the two elements. For those of ordinary skill in the art, specific meanings of the above terms in the embodiments of the present disclosure may be understood according to specific situations.

In the accompanying drawings corresponding to the embodiments of the present disclosure, for better understanding and case of description, the thickness and area of a layer are enlarged. When a component (e.g., a layer, a film, a region, or a substrate) is described as being formed over another component or over a surface of another component, the component may be “directly” on the surface of another component, or a third component may exist between the two components. In contrast, when a component is described as being formed on a surface of another component or a surface of a component is formed or provided with another component, there is no third component between the two components. In addition, when a component is described as being “substantially” formed on/over another component, it means that the component is not formed on/over the entire surface (or front surface) of another component, nor on/over a portion of the edge of the entire surface.

In the description of the embodiments of the present disclosure, when a component “includes” another component, unless otherwise stated, other components are not excluded, and other components may be further included in the component. In addition, when a component such as a layer, a film, a region, or a plate is referred to as being “over/disposed over” another component, it may be “directly on” another component (i.e., being on the surface of another component and there is no other component therebetween), or another component may exist therebetween. Furthermore, when a component such as a layer, film, region, plate, etc. is “directly on” another component, or when a component such as a layer, film, region, plate, etc. is disposed on the surface of another component, it means that no other component is disposed therebetween.

The terms used in the description of the various described embodiments herein are for the purpose of describing particular embodiments only and is not intended to be limiting. As used in the description of the various embodiments described and the appended claims, “the portion” is also intended to include the plural forms as well, unless the context clearly indicates otherwise. The component includes a layer, a film, a region, or a plate, etc.

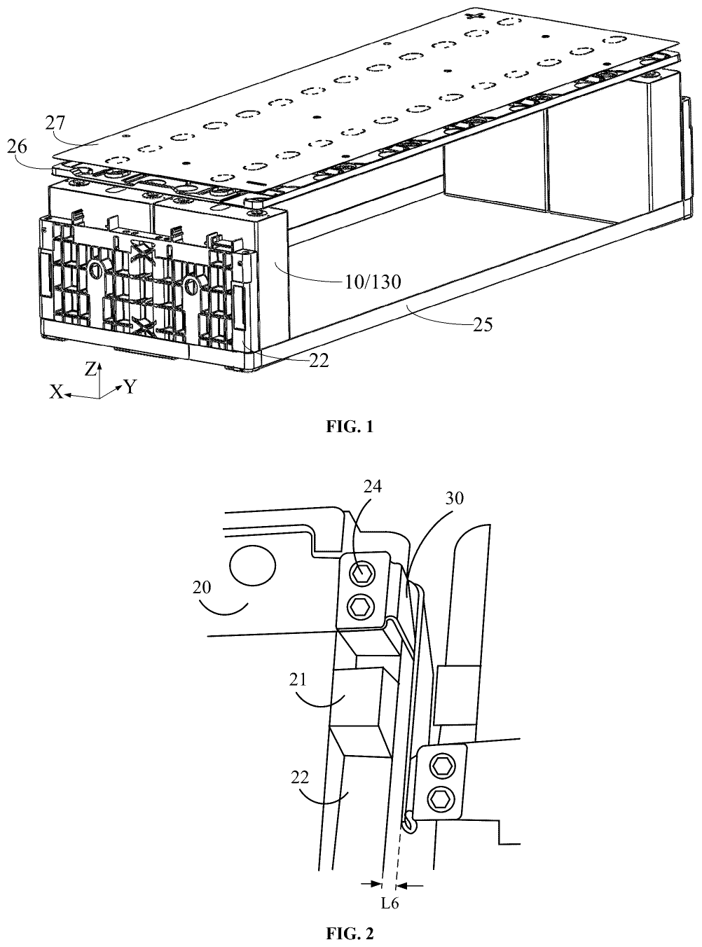

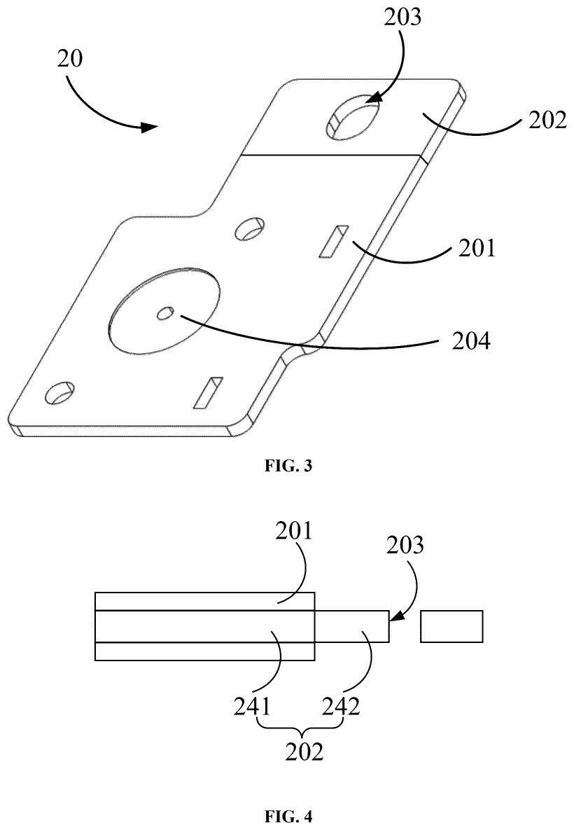

According to some embodiments of the present disclosure, with reference to FIGS. 1 and 2, a battery module is provided. The battery module includes at least two battery cell groups and at least one connecting member 30. Each respective battery cell group includes an output connector 20, and a plurality of battery cells 10 arranged sequentially in a first direction Y. Each battery cell 10 has two electrodes, and the plurality of battery cells 10 includes an outermost battery cell 130 having an electrode as an output electrode. The output connector 20 includes a first electrical connection 201 and a second electrical connection 202 that are integrally formed (with reference to FIG. 3). The first electrical connection 201 is in electrical contact with the output electrode, and has a material different from a material of the second electrical connection 202. Two ends of a respective connecting member 30 are in electrical contact with second electrical connections 202 of output connectors 20 of respective two battery cell groups of the at least two battery cell groups, respectively. FIG. 2 is a schematic view illustrating a partial structure of a battery module according to an embodiment of the present disclosure.

In some embodiments, a battery cell group is a unit assembled from a plurality of battery cells 10 to provide higher voltage and capacity. The battery cell group is a component in a battery system and typically consists of a number of battery cells, connectors, a battery management system (BMS), an enclosure, and the like.

The main function of the battery module is to connect a plurality of battery cell groups together to increase the voltage and storage capacity of the battery system. By connecting battery cells in parallel or series, the battery module can meet power requirements in different applications. Connection of battery cells in series can increase the total voltage, and connection of battery cells in parallel can increase the total capacity. The battery module may be a 350 module, a 390 module, or a 530 module.

In some embodiments, the battery cell 10, which is the smallest unit of the battery, is an electrical energy storage unit and must have a high energy density to store as much electrical energy as possible. In addition, the service life of the battery cell is the most critical factor, and damage to any one battery cell may result in damage to the entire battery pack.

In some embodiments, each battery cell group includes the plurality of battery cells 10 arranged sequentially in the first direction, and the plurality of battery cells 10 are connected in series to each other by means of bus connectors. Each battery cell include a positive electrode, a negative electrode, and an explosion-proof port, and two ends of a bus connector are electrically connected to electrodes of two battery cells respectively. For example, the bus connector is electrically connected to a positive electrode of one of the two battery cells and a negative electrode of the other of the two battery cells.

In some embodiments, the bus connector may be aluminum bar. The resistance and price of the aluminum bar are low, weldability between a material of the aluminum bar and materials of the positive and negative electrodes is relatively high, and the aluminum bar can reduce the contact resistance between the bus connector and the batter cells.

In some embodiments, each of two ends of the battery cell group has an output electrode. The output electrode refers to one of electrodes of an outermost battery cell 130, and the output connector is connected to the output electrode. The output connector may be a composite connector, i.e., a composite connector including a first electrical connection and a second electrical connection.

In some embodiments, referring to FIG. 3 which is a schematic view illustrating a sectional structure of a first type of output connector in a battery module according to an embodiment of the present disclosure, the output connector 20 includes a first electrical connection 201 and a second electrical connection 202 that are integrally formed. The first electrical connection 201 is in electrical contact with the output electrode, and has a material different from a material of the second electrical connection 202. For the first electrical connection 201 electrically connected to the battery cell 10, the material of the first electrical connection 201 may be suitably selected according to the consideration of a potential difference between the first electrical connection 201 and the battery cell, which can avoid an undesirable problem caused by the redox reaction due to the potential difference between the first electrical connection 201 and a positive pole or a negative pole in the battery cell. The first electrical connection 201 may be also provided to include a material having better weldability with a material of the positive pole or the negative pole of the battery cell, so as to improve the contact performance between the first electrical connection and the positive pole or the negative pole of the battery cell. For the second electrical connection 202, more consideration is given to the overcurrent between the second electrical connection 202 and the connecting member 30. The first electrical connection 201 and the second electrical connection 202 are designed to be integrally formed so that the welding difference between different materials can be avoided. In this way, there are better contact performance and less contact loss between the battery cell, output connector 20 and connecting member 30, thus improving the yield of the battery module.

In some embodiments, the material of the first electrical connection 201 has a resistivity of 1.6×10⁻⁸ Ω·m to 5.0×10⁻⁷ Ω·m. The resistivity may be 1.6×10⁻⁸ Ω·m to 3.0×10⁻⁸ Ω·m, 3×10⁻⁸ Ω·m to 7×10⁻⁸ Ω·m, 7×10⁻⁸ Ω·m to 9.3×10⁻⁸ Ω·m, 9.3×10⁻⁸ Ω·m to 2×10⁻⁷ Ω·m, 2×10⁻⁷ Ω·m to 3.1×10⁻⁷ Ω·m, or 3.1×10⁻⁷ Ω·m to 5×10⁻⁷ Ω·m. With the resistivity of the material of the first electrical connection 201 in any of the above ranges, the first electrical connection 201 itself has less resistance loss, which enables less contact loss between the battery cells 10 and the output connector 20.

In some embodiments, the material of the second electrical connection 202 has a current-carrying capacity of 3 A/mm² to 10 A/mm². The current-carrying capacity may be 3 A/mm² to 4.6 A/mm², 4.6 A/mm² to 6.8 A/mm², 6.8 A/mm² to 7.3 A/mm², or 7.3 A/mm² to 10 A/mm². A larger current-carrying capacity of the second electrical connection 202 allows a larger capacity of accommodating current in a total output end of the battery module, which in turn ensures the safety and stability of the output connector 20.

In some embodiments, the material of the first electrical connection 201 is a mono-metal or a metal alloy, the mono-metal is the same as a material of the output electrode, and the metal alloy includes the same metal as the output electrode. In this way, the first electrical connection 201 is consistent with the output electrode in welding eutectic characteristics, and in spot welding, it is easy for the metals to be homogeneously eutectic and the melting pool to be uniform, which improves the reliability of welded joints and ensures the welding performance between the output connector 20 and the output electrode.

In some embodiments, the material of the first electrical connection 201 includes aluminum. Aluminum is relatively low in resistance and price, has relatively high weldability with the material of the positive electrode and the negative electrode, and thus can reduce the contact resistance between the output connector 20 and the battery cell.

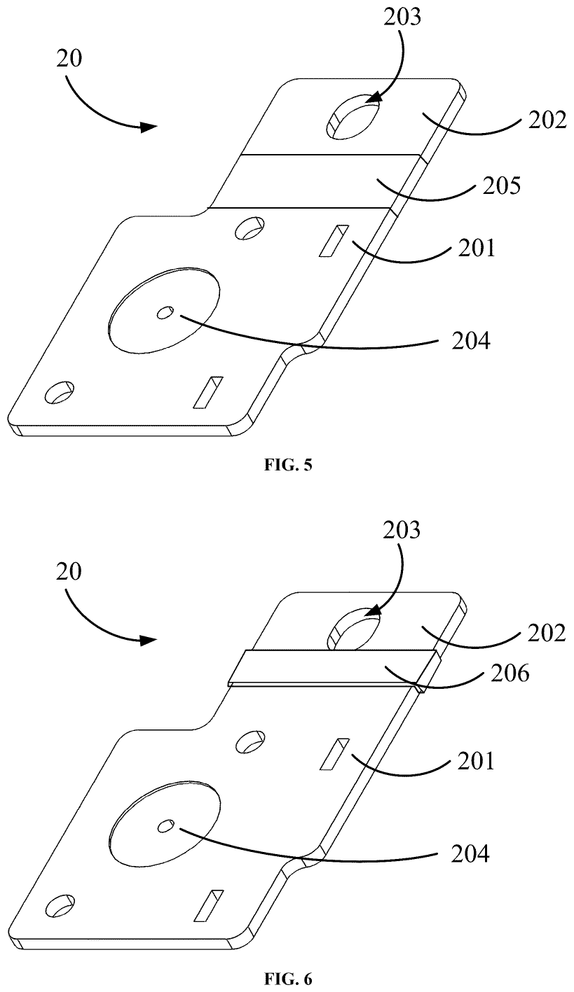

In some embodiments, referring to FIG. 4 which is a schematic view illustrating a sectional structure of a second type of output connector in a battery module according to an embodiment of the present disclosure, the second electrical connection 202 includes a first sub-electrical connection 241 and a second sub-electrical connection 242 that are integrally formed, the first electrical connection 201 wraps the first sub-electrical connection 241, the first sub-electrical connection 241 is electrically connected to the output electrode, and the second sub-electrical connection 242 is electrically connected to the connecting electrode. In this way, the second electrical connection 202 includes two parts, the first electrical connection 201 is welded to the output electrode, and a contact surface between the first sub-electrical connection 241 and the first electrical connection 201 includes all the surface of the second electrical connection 202 except a surface of the second sub-electrical connection 242, i.e., there is a larger contact surface between the first electrical connection 201 and the first sub-electrical connection 241 to transmit the current, thus improving the contact performance between the first electrical connection 201 and the second electrical connection 202. In some embodiments, referring to FIG. 5 which is a schematic view illustrating a structure of a third type of output connector in a battery module according to an embodiment of the present disclosure, the output connector 20 further includes: a third electrical connection 205 disposed between the first electrical connection 201 and the second electrical connection 202. The material of the third electrical connection 205 includes silver, gold, nickel, or tin. The third electrical connection 205 may be used as a current transmission medium between the first electrical connection 201 and the second electrical connection 202, which can avoid problems such as a relatively high contact resistance caused by poor intermeltability of materials between the first electrical connection 201 and the second electrical connection 202, and corrosion caused by the presence of potential difference.

In some embodiments, referring to FIG. 6 which is a schematic view illustrating a structure of a fourth type of output connector in a battery module according to an embodiment of the present disclosure, the output connector 20 further includes: a fourth electrical connection 206 surrounding at least a junction of the first electrical connection and the second electrical connection. In this way, the fourth electrical connection 206 can enclose the junction between the first electrical connection 201 and the second electrical connection 202, which can effectively avoid mutual detachment and corrosion between the first electrical connection 201 and the second electrical connection 202, thereby improving the safety and service life of the output connector 20.

In some embodiments, the fourth electrical connection 206 is a ring structure sleeved at the junction between the first electrical connection 201 and the second electrical connection 202. A surface of the first electrical connection 201 is flush with a surface of the second electrical connection 202, and the fourth electrical connection 206 protrudes from both the surface of the first electrical connection 201 and the surface of the second surface of the second electrical connection 202. Alternatively, an annular depression is formed at the junction of the first electrical connection 201 and the second electrical connection 202, and the fourth electrical connection 206 is disposed within the depression, where the fourth electrical connection 206, the first electrical connection 201 and the second electrical connection 202 snap together. In this way, the fourth electrical connection 206 completely closes the junction of the first electrical connection 201 and the second electrical connection 202, thereby reducing the chance of redox reactions occurring between the first electrical connection 201 and the second electrical connection 202 from the outside world. The fourth electrical connection 206 is in contact with the first electrical connection 201, and the fourth electrical connection 206 is in contact with the second electrical connection 202, and in comparison with the first electrical connection 201 and the second electrical connection 202, the contact formed by the fourth electrical connection 206, the first electrical connection 201 and the second electrical connection 202 forms a larger contact area and better contact performance, which helps the overcurrent of the current and improves the yield of the output connector.

In some embodiments, the second electrical connection 202 is integrally formed with the connecting member 30. In this way, there is no need to use a connection method such as screws to secure the output connector 20 to the connecting member 30, and the connection impedance between the output connector 20 and the connecting member 30 can be lowered, thereby improving the soldering effect between the output connector 20 and the connecting member 30.

In some embodiments, the material of the second electrical connection 202 is the same as the material of the connecting member 30 so that there is no threshold between the second electrical connection 202 and the connecting member 30, and a current can be transferred from the second electrical connection 202 to the connecting member 30 more easily. The material of the second electrical connection 202 is the same as the material of the connecting member 30 so that there is a better welding performance between the second electrical connection 202 and the connecting member 30, thereby avoiding situations such as cold joint caused by a relatively high connection impedance between the second electrical connection 202 and the connecting member 30 and poorer quality of the welded joints.

In some embodiments, the material of the second electrical connection 202 includes copper. Firstly, the copper has a lower resistance, so that there is less loss in the process of transmitting the current; secondly, the copper is cheaper, so that the preparation cost of the whole battery pack is lower; and thirdly, the copper has a larger current carrying capacity, so that it can ensure that a current of a battery cell group is transmitted via an output electrode without a major safety hazard.

In some embodiments, the thickness of the first electrical connection 201 is less than or equal to the thickness of the second electrical connection 202. Thus, the second electrical connection 202 has a relatively large thickness and thus has a relatively large volume as the total output end of the battery cell group, and the second electrical connection 202 has a relatively large overcurrent to ensure the safety of the battery cell group. The second electrical connection 202 is connected to the connecting member 30, i.e., the second electrical connection 202 serves as the total output end of the battery cell group, and when the second electrical connection 202 has a relatively large thickness, the cross-sectional area of the second electrical connection 202 is also smaller, so that the resistance value of the second electrical connection 202 itself can be reduced.

In addition, the second electrical connection 202 has a relatively large thickness, and is configured to be connected to the connecting member 30. When the second electrical connection 202 has a relatively large thickness, the bearing capacity, strength, and torque of the second electrical connection 202 will correspondingly increase, thereby avoiding problems such as breakage and cracks occurring in the assembly process of the second electrical connection 202 and the connecting member 30.

In some embodiments, the top surface of the first electrical connection 201 is flush with the top surface of the second electrical connection 202 in the vertical direction. In this way, there is no height difference between the first electrical connection 201 and the second electrical connection 202, and there is no need to consider alignment issues and offsets of the connecting member 30.

In some embodiments, the connection between the output connector 20 and the connecting member 30 is achieved by means of a stud 24 (refer to FIG. 2), ultrasonic welding, or thermocompression welding.

In some embodiments, the output connector 20 further includes a fixing hole 203 for mating with a mounting hole of the connecting member 30 and a soldering hole 204 for soldering with the output electrode.

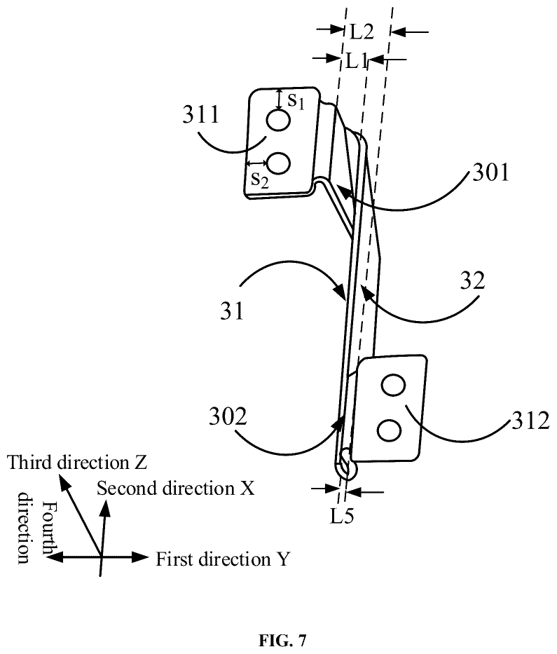

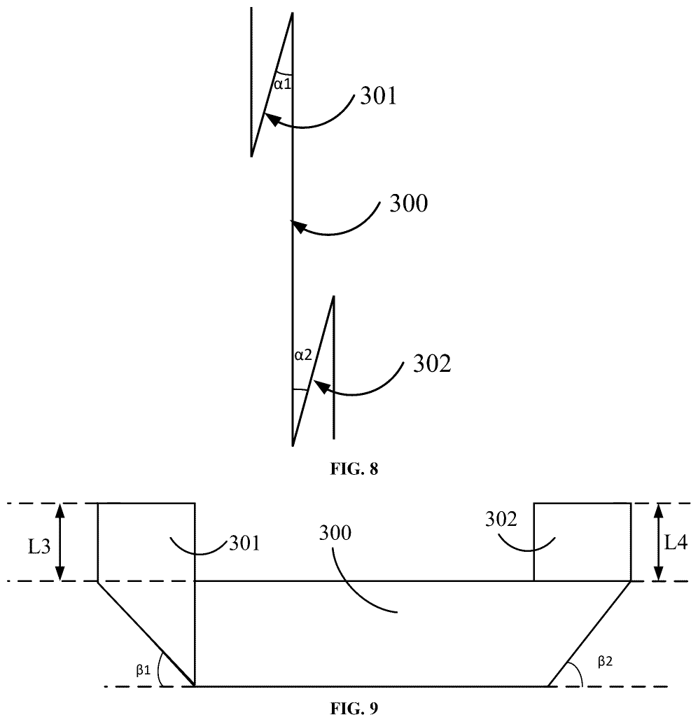

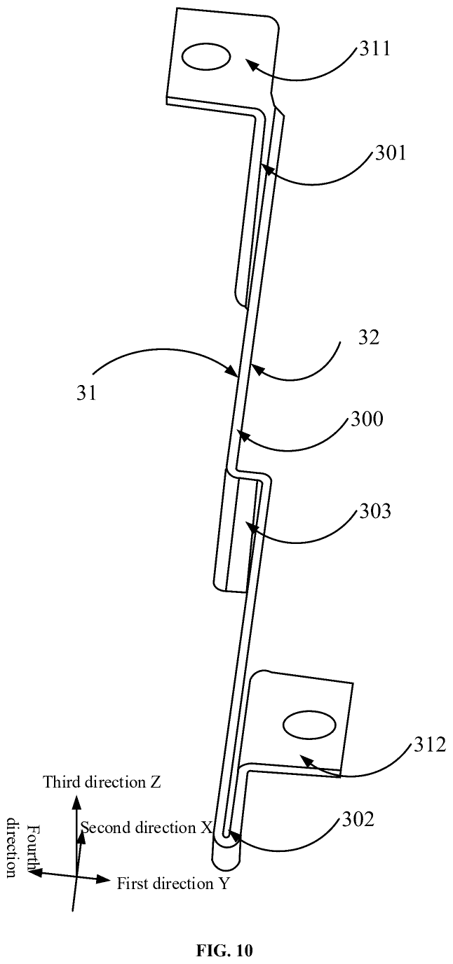

FIG. 7 is a schematic view illustrating a structure of a connecting member in a battery module according to an embodiment of the present disclosure. FIG. 8 is a schematic diagram illustrating bending in FIG. 7. FIG. 9 is a left view of FIG. 7. FIG. 10 is a schematic view illustrating another structure of the connecting member in the battery module according to an embodiment of the present disclosure.

In some embodiments, referring to FIG. 2 and FIG. 7, the connecting member 30 includes: a body portion 300 (referring to FIG. 8) having a first side 31 and a second side 32 opposite to each other, where the body portion 300 extends from a second end of the body portion 300 to a first end of the body portion 300 in a second direction X and from a first edge of the body portion 300 to a second edge of the body portion 300 in a third direction Z; a first bending portion 301 and a second bending portion 302, where the first bending portion 301 and the second bending portion 302 are respectively disposed at the first end and the second end of the body portion, the first bending portion 301 is connected to the first end of the body portion and is bent from the first end of the body portion 300 towards the third direction Z on the first side 31 of the body portion 300, and the second bending portion 302 is connected to the second end of the body portion 300 and is bent from the second end of the body portion 300 towards the third direction Z on the second side 32 of the body portion 300; a first connecting portion 311, where the first connecting portion 311 is connected to an end of the first bending portion 301 away from the body portion 300 and is bent from the end of the first bending portion 301 towards a fourth direction, and the fourth direction is a direction from the second side 32 to the first side 31; and a second connecting portion 312, where the second connecting portion 312 is connected to an end of the second bending portion 302 away from the body portion 300 and is bent from the end of the second bending portion 302 towards the first direction Y, and the first direction Y is a direction from the first side 31 to the second side 32.

In some embodiments, through a fit between the first bending portion 301, the second bending portion 302, the first connecting portion 311 and the second connecting portion 312, the length of the connecting member 30 is no longer limited by a gap between the battery cell groups, i.e., the length direction of the connecting member 30 is changed from the row direction of two battery cell groups to the vertical and horizontal directions, so that the width direction of the body portion 300 can be the vertical direction of the battery module. In this way, at least the length of the connecting member 30 in the length direction can be increased to the width of one battery cell group and the height of the battery cell group. Compared with the previous scheme in which the connecting member 30 electrically connects adjacent battery cell groups in the horizontal direction, this scheme can increase the length of the connecting member 30, thereby ensuring that the connecting member 30 has a sufficient length to ensure the current-carrying problem between the total output terminals, thereby avoiding thermal problems caused by excessive current-carrying in the battery module and current-carrying losses.

In addition, by changing the structure of the connecting member 30 and the special bending directions, the gap between the two battery cell groups does not need to make way for the length for the current-carrying and the mounting problem, so that the gap between the two battery cell groups can be shortened to reduce some space in the length direction of the battery cell group so as to make way for other components, improving the integration of the battery module.

In some embodiments, the length direction of the connecting member 30 is changed from the row direction of the two battery cell groups to the vertical and the horizontal directions, so that the areas of the first side 31 and the second side 32 do not need to be limited to make way for a low-voltage connector 21 (refer to FIG. 2) and to avoid interference of the connecting member 30 with the low-voltage connector 21. The cross-sections of the first side 31 and the second side 32 or the body portion 300 can be extended in the height direction of the battery cell, thereby increasing the cross-sectional area of the connecting member 30 and decreasing the resistance of the connecting member 30.

In some embodiments, referring to FIG. 8, the first bending portion 301 and the first side 31 has a first included angle α1, the second bending portion 302 and the second side 32 has a second included angle α2, and at least one of the first included angle α1 and the second included angle α2 is in a range of 0° to 30°, which may be, for example, 0°, 8°, 13°, 16°, 22°, 26°, 30°, etc. With either of the first included angle α1 and the second included angle α2 being in the above range, the deformation degree of the first bending portion 301 can satisfy and offset an installation tolerance between the two cell modules, and the deformation of the first bending portion 301 does not exceed a deformation degree of the connecting member 30 itself, so that the connecting member 30 itself has a large strength and structural strength. Moreover, the deformation degree of the first bending portion 301 also needs to ensure that there is no interference between edges of the first bending portion 301 and second bending portion 302 and the cell module. Similarly, the deformation degree of the second bending portion 302 also has the same technical effect as that of the first bending portion 301, which is not repeated herein.

In some embodiments, referring to FIG. 9, the first bending portion 301 has a first bending angle β₁, the second bending portion 302 has a second bending angle β2, and at least one of the first bending angle β₁ and the second bending angle β₂ is in a range of 0° to 90°, which may be, for example, 0°, 20°, 30°, 45°, 53°, 66°, 90°, etc. With either of the first bending angle β₁ and the second bending angle β₂ being in the above range, a length of the first bending portion 301 in the first direction is not relatively long, so that the body portion 300 has a larger space, thereby improving the length of the connecting member 30. Similarly, the deformation degree of the second bending portion 302 also has the same technical effect as that of the first bending portion 301, which is not repeated herein.

In some embodiments, the length extension direction of the body portion 300 may not be perpendicular to the third direction Z, i.e., the length extension direction of the body portion 300 may intersect with the second direction at an angle between 0 and 90°. When the length extension direction of the body portion 300 is perpendicular to the second direction, the connecting member 30 may have a larger length to transmit the current through the cooperation of the first bending portion 301 with the second bending portion 302.

In some embodiments, the width of the body portion 300 may be the same as the widths of the first bending portion 301 and the second bending portion 302, and the width of the body portion 300 may also be larger than the widths of the first bending portion 301 and the second bending portion 302. The embodiments of the present disclosure do not limit the size relationship in width between the body portion 300 and the first bending portion 301.

Similarly, the thickness of the body portion 300, the thickness of the first bending portion 301, the thickness of the second bending portion 302, the thickness of the first connecting portion 311, and the thickness of the second bending portion 302 may be set by the person skilled in the art according to actual needs, which is not limited in the present disclosure.

In some embodiments, referring to FIG. 7, the distance between the first bending portion 301 and the first side 31 along the first direction Y is a first distance L1, the distance between the first bending portion 301 and the second bending portion 302 along the first direction Y is a second distance L2, and the ratio of the first distance L1 to the second distance L2 ranges from 1% to 50%, which may be, for example, 1%, 10%, 23%, 38%, 43%, 50%, etc. With the ratio of the first distance L1 to the second distance L2 being in the above range, the first bending portion 301 has a larger space for deformation, which can alleviate the installation tolerance between the two battery cell groups so as to improve the yield of the cell module, and the distance between the first bending portion 301 and the body portion 300 causes a gap between the body portion 300 and the battery cell group, thereby improving the heat dissipation of the connecting member 300. In some embodiments, referring to FIG. 7, the second bending portion 302 and the second side 12 has a fifth distance L5, and a ratio of the fifth distance L5 to the second distance L2 is in a range of 1% to 50%, which may be, for example, 1%, 10%, 23%, 38%, 43%, 50%, etc. With the ratio of the fifth distance L5 to the second distance L2 being in the above range, the second bending portion 302 has a larger space for deformation, which can alleviate the installation tolerance between the two battery cell groups so as to improve the yield of the cell module, and the distance between the second bending portion 302 and the body portion 300 causes a gap between the body portion 300 and the battery cell group, thereby improving the heat dissipation of the connecting member 30.

In some embodiments, the first distance L1 is in the range of 0 mm to 2.5 mm, which may be, for example, 0 mm, 0.8 mm, 1.3 mm, 1.6 mm, 2.0 mm, 2.5 mm, etc. With the first distance L1 being in the above range, there is a gap between the first bending portion 301 and the body portion 300 to avoid interference and improve the heat dissipation function of the connecting member 30. The first distance L1 being in the above range can also reduce the distance between the two battery cell group, so that more cells are integrated in a limited space, and the energy storage battery pack has a larger battery capacity.

In some embodiments, referring to FIG. 9, the distance between the first connecting portion 311 and the body portion 300 is a third distance L3, the distance between the second connecting portion 312 and the body portion 300 is a fourth distance L4, and at least one of the third distance L3 and the fourth distance L4 is in the range of 2 mm to 100 mm. The lengths of the third distance L3 and the fourth distance LA are used to ensure that there is no interference between the body portion 300 and the low-voltage connector on the end plate, while the length of the connecting member 30 itself is moderate, where the length of the connecting member 30 being moderate means that the length of the connecting member 30 can meet the current-carrying requirements of the connecting member 30, and is not too long, resulting in a waste of material.

In some embodiments, referring to FIG. 10, the body portion 300 has a first buffer structure 303 disposed between the first bending portion 301 and the second bending portion 302. The first buffer structure 303 is configured to reduce the effect of jitter between two adjacent battery cell groups, and can avoid the breaking of welding spots between the connecting member 30 and the battery cell groups.

In some embodiments, a plane where the first direction Y and the third direction X are located constitutes a reference surface, and an orthographic projection of the first buffer structure 303 on the reference surface has a wave shape or a folding line shape. The design of the first buffer structure 303 can effectively utilize the material area, and the first buffer structure 303 does not cause the body portion 300 to be disconnected. The first buffer structure 303 is a bending design and a deformation process of the body portion 300, and the connecting member 30 is an integrally formed structure without a fracture opening, so that the current-carrying capacity of the connecting member 30 does not change, and an internal resistance of the connecting member 30 is also small. The strength of the connecting member is relatively large, which improves the stability and reliability of the cell module.

In some embodiments, the connecting member 30 further includes a second buffer structure disposed on at least one of the first bending portion 301 or the second bending portion 302. Providing the second buffer structure may further improve the stability and the reliability of the connecting member 30.

In some embodiments, the orthographic projection of the second buffer structure on the reference plane includes a wave shape or a fold line shape.

In some embodiments, the maximum length of the first buffer structure 303 along the third direction is less than 2 mm, so as to avoid interference problems between the first buffer structure 303 and other components.

With continued reference to FIG. 7, each of the first connecting portion 311 and the second connecting portion 312 has a mounting hole for riveting with an output member. Taking the mounting hole on the first connecting portion 311 as an example, an edge of the mounting hole and an edge of the first connecting portion 311 has a first edge distance S1 in the second direction, and the first edge distance S1 is greater than or equal to 20 mm. The edge of the mounting hole and the edge of the first connecting portion 311 has a second edge distance S2 in the first direction, and the second edge distance S2 is greater than or equal to 20 mm. With the first edge distance S1 and the second edge distance S2 being in the above range, the probability of breakage of the edge during subsequent mounting of the screw is reduced.

In some embodiments, the width and thickness of the connecting member 30 (the cross-sectional area of the connecting member 30) may be set according to an over-current requirement of the entire battery cell group, which is not limited in the present disclosure.

With continued reference to FIG. 1, the battery module further includes a cells contact system (CCS) harness plate 26 and an isolation device 27. The CCS harness plate 26 is disposed above the battery cell groups, the respective output connector 20 is disposed on the CCS harness plate 26, and the respective output electrode runs through the CCS harness plate 26 in the thickness direction and is welded to the respective output connector 20. The isolation device 27 is disposed on the respective output connector 20, and is configured to achieve isolation between the respective output connector 20 and a top plate.

In some embodiments, the battery module further includes an end plate 22 disposed on a side of the battery cell group along the first direction X; and at least one fixing member 25 configured to encircle the battery cell groups and the end plate 22 and provide a preload.

In some embodiments, the end plate 22 may be a plastic end plate, a metal end plate, or a composite end plate, so that the end plate 22 itself has a high strength to withstand the expansion and deformation of the battery cell, the vibration of the energy storage battery pack, the impact and other conditions, and the weight of the end plate 22 itself is strong, so that it is easy to achieve lightweight.

In some embodiments, the material of the fixing member 25 may include stainless steel, high-strength steel, or plastic. The fixing member 25 is generally annular, and the fixing member 25 is sleeved on the end plate 22 after the battery cell groups are stacked and extruded. Joints of a metal fixing member may be laser welding, metal latches, etc. Joints of a plastic fixing member may be heat fused connections. Considering size requirements, insulation protection, etc., the joints are generally provided at the position of the end plate 22.

Accordingly, according to some embodiments of the present disclosure, the present disclosure further provides an energy storage battery pack, including a plurality of battery modules of any one of the above embodiments.

In some embodiments, the energy storage battery pack is a monolithic unit assembled from a plurality of battery modules to store and provide electrical energy. The energy storage battery pack typically includes a plurality of battery modules, connectors, a battery management system (BMS), a heat dissipation system, electrical interfaces, an enclosure and the like.

The BMS is configured to monitor and manage the charging and discharging process of the battery to ensure the safety and stable performance of the battery. The BMS can monitor parameters of the battery cell such as a voltage, a temperature and a current, perform battery status estimation and balance control to avoid overcharging, over-discharging, over-temperature and so on, and provide a communication interface for data interaction with an external system.

The battery modules are connected in parallel or in series to increase the voltage, capacity or power of the battery system. The energy storage battery pack is also responsible for providing other functions and characteristics required by the battery system, such as an electrical interface for connection to an external system.

In some embodiments, the energy storage battery pack typically further includes a heat dissipation system for controlling the battery temperature. Through the heat dissipation system, the battery modules can be effectively cooled, preventing overheating and maintaining the battery within a suitable operating temperature range.

In some embodiments, the energy storage battery pack further includes an enclosure or protective structure for protecting the battery modules and the BMS, and providing physical support and isolation, while ensuring the safety and reliability of the battery system. The enclosure may provide protection, heat dissipation, and shielding of the battery system from damage from the external environment.

Although some embodiments are disclosed in the present disclosure, they are not intended to limit the claims, any person skilled in the art can make several possible variations and modifications without departing from the concept of the present disclosure, and therefore, the protection scope of the present disclosure shall be subject to the scope defined by the claims of the present disclosure.

A person of ordinary skill in the art may understand that the foregoing implementations are specific embodiments for implementing the present disclosure, and in practical applications, various changes may be made in form and detail without departing from the scope of the present disclosure. Any person skilled in the art may make various changes and modifications without departing from the scope of the present disclosure, and therefore, the protection scope of the present disclosure shall be subject to the scope defined by the claims.

What is claimed is:

1. A battery module, comprising:
at least two battery cell groups, wherein each respective battery cell group of the at least two battery cell groups includes an output connector, and a plurality of battery cells arranged sequentially in a first direction, each of the plurality of battery cells has two electrodes, the plurality of battery cells includes an outermost battery cell having an electrode as an output electrode, the output connector includes a first electrical connection and a second electrical connection that are integrally formed, the first electrical connection is in electrical contact with the output electrode, and the first electrical connection has a material different from a material of the second electrical connection; and
at least one connecting member, wherein two ends of each respective connecting member of the at least one connecting member are in electrical contact with second electrical connections of output connectors of respective two battery cell groups of the at least two battery cell groups, respectively.

2. The battery module according to claim 1, wherein the material of the first electrical connection has a resistivity of 1.6×10⁻⁸ Ω·m to 5.0×10⁻⁷ Ω·m, and the material of the second electrical connection has a current-carrying capacity of 3 A/mm² to 10 A/mm².

3. The battery module according to claim 1, wherein the material of the first electrical connection is a mono-metal or a metal alloy, the mono-metal being the same as a material of the output electrode, and the metal alloy including the same metal as the output electrode.

4. The battery module according to claim 3, wherein the material of the first electrical connection includes aluminum.

5. The battery module according to claim 1, wherein the second electrical connection includes a first sub-electrical connection and a second sub-electrical connection that are integrally formed, the first electrical connection wraps the first sub-electrical connection, the first sub-electrical connection is electrically connected to the output electrode, and the second sub-electrical connection is in electrical contact with the connecting member.

6. The battery module according to claim 1, wherein the output connector further includes a third electrical connection disposed between the first electrical connection and the second electrical connection, a material of the third electrical connection including silver, gold, nickel or tin.

7. The battery module according to claim 1, wherein the output connector further includes a fourth electrical connection surrounding at least a junction of the first electrical connection and the second electrical connection.

8. The battery module according to claim 1, wherein the second electrical connections are integrally formed with the respective connecting member.

9. The battery module according to claim 8, wherein materials of the second electrical connections are the same as a material of the respective connecting member.

10. The battery module according to claim 1, wherein the material of the second electrical connection includes copper.

11. The battery module according to claim 1, wherein the first electrical connection has a thickness less than or equal to a thickness of the second electrical connection.

12. The battery module according to claim 1, wherein the first electrical connection is flush with the second electrical connection in a vertical direction.

13. The battery module according to claim 1, wherein the respective connecting member includes:
a body portion, having a first side and a second side opposite to each other, wherein the body portion extends from a second end of the body portion to a first end of the body portion in a second direction and from a first edge of the body portion to a second edge of the body portion in a third direction;
a first bending portion and a second bending portion, wherein the first bending portion and the second bending portion are respectively disposed at the first end and the second end of the body portion, the first bending portion is connected to the first end of the body portion and is bent from the first end of the body portion towards the third direction on the first side of the body portion, and the second bending portion is connected to the second end of the body portion and is bent from the second end of the body portion towards the third direction on the second side of the body portion;
a first connecting portion, wherein the first connecting portion is connected to an end of the first bending portion away from the body portion and is bent from the end of the first bending portion towards a fourth direction, and the fourth direction is a direction from the second side to the first side; and
a second connecting portion, wherein the second connecting portion is connected to an end of the second bending portion away from the body portion and is bent from the end of the second bending portion towards the first direction, and the first direction is a direction from the first side to the second side.

14. The battery module according to claim 13, wherein the first bending portion and the first side have a first distance in the first direction, the first bending portion and the second bending portion have a second distance in the first direction, and a ratio of the first distance to the second distance is in a range of 1% to 50%.

15. The battery module according to claim 14, wherein the first distance ranges from 0 mm to 2.5 mm.

16. The battery module according to claim 13, wherein the body portion has a buffer structure disposed between the first bending portion and the second bending portion.

17. The battery module according to claim 16, wherein a maximum length of the first buffer structure along the third direction is less than 2 mm.

18. The battery module according to claim 16, wherein an orthographic projection of the buffer structure on a reference surface has a wave shape or a folding line shape, the reference surface being constituted by a plane where the first direction and the third direction.

19. The battery module according to claim 9, wherein the material of the second electrical connection includes copper.

20. An energy storage battery pack, comprising a plurality of the battery modules, wherein each of the plurality of the battery modules includes:
at least two battery cell groups, wherein each respective battery cell group of the at least two battery cell groups includes an output connector, and a plurality of battery cells arranged sequentially in a first direction, each of the plurality of battery cells has two electrodes, the plurality of battery cells includes an outermost battery cell having an electrode as an output electrode, the output connector includes a first electrical connection and a second electrical connection that are integrally formed, the first electrical connection is in electrical contact with the output electrode, and the first electrical connection has a material different from a material of the second electrical connection; and
at least one connecting member, wherein two ends of each respective connecting member of the at least one connecting member are in electrical contact with second electrical connections of output connectors of respective two battery cell groups of the at least two battery cell groups, respectively.
